(19) United States
(12) Patent Application Publication
(10) Pub. No.: US 2024/0133805 A1
(43) Pub. Date: Apr. 25, 2024

(54) METHOD FOR DETERMINING THE PHASE AND/OR REFRACTIVE INDEX OF A REGION OF AN OBJECT, AND MICROSCOPE FOR DETERMINING THE PHASE AND/OR REFRACTIVE INDEX OF A REGION OF AN OBJECT

(71) Applicant: Carl Zeiss Microscopy GmbH, Jena (DE)

(72) Inventors: Dirk SEIDEL, Jena (DE); Christoph HUSEMANN, Jena (DE); Lars STOPPE, Jena (DE)

(21) Appl. No.: 18/485,286

(22) Filed: Oct. 11, 2023

(30) Foreign Application Priority Data
Oct. 12, 2022 (DE) 102022126509.9

(51) Int. Cl. G01N 21/41; G02B 21/06

(52) U.S. Cl. CPC G01N 21/4133; G02B 21/06

(57) ABSTRACT

In a method for determining the phase and/or refractive index of a region of an object, the object region is illuminated with coherent or partly coherent light and is imaged into the image plane a number of times with different imaging properties and is recorded in order to obtain a plurality of intensity recordings of the object region. The phase and/or refractive index determination is carried out based upon the plurality of intensity recordings. The different imaging properties differ at least in terms of different phase shifts which are additionally introduced into the imaging beam path, and which are generated differently than by changing the focusing when carrying out the recordings. The different phase shifts which are additionally introduced into the imaging beam path are effected by introducing at least one optical element into the objective and/or manipulating at least one optical element of the objective.

### PRIORITY

This application claims priority of German patent application no. 10 2022 126 509.9, filed Oct. 12, 2022, the entire content of which is incorporated herein by reference.

### FIELD

The present invention relates to a method and a microscope for determining the phase and/or refractive index of a region of an object.

### BACKGROUND

Known microscopes, such as e.g. wide-field microscopes or confocal microscopes, can be used to carry out magnified intensity recordings of a region of an object. However, there is often interest in the phase of the object region since further valuable information about the object region can be obtained therefrom. For example, the refractive index and/or an etching depth of sample materials can thus be derived therefrom.

In this respect there are applications in the biosciences, such as e.g. the imaging of transparent objects, such as e.g. cells, the imaging of tissue, the monitoring of cell growth etc. In the field of material inspection, too, there is interest in determining the object phase, particularly in the field of semiconductor fabrication (for example the inspection of an etching depth of lithographically etched objects, such as e.g. photomasks). Semiconductor wafers, photonic integrated circuits or microelectromechanical systems are also preferred fields of application.

Modern photomasks for semiconductor production (in particular so-called DUV photomasks for wavelengths of e.g. 365 nm, 248 nm and 193 nm) not only have binary structures but contain phase-changing properties. Such photomasks are formed for example by etching (CPL; Chromeless Phase-Shifting Lithography) or from phase-shifting materials (MoSi). For EUV masks (EUV=extreme ultraviolet, e.g. wavelength of 13.5 nm), phase-shifting properties and materials are currently being investigated. The phase-shifting properties are crucial for metrology within the process for producing photomasks. Multilayer defects of DUV or EUV blanks (DUV=deep ultraviolet, e.g. wavelength of 193 nm or 238 nm) will occur as a phase defect in a scanner or a measuring tool. Such phase defects are virtually impossible to find with intensity recordings.

Therefore, there is interest in reconstructing the object phase from measured intensity recordings and many algorithms have already been developed for this purpose. Known techniques are phase reconstructions by means of iterative Fourier transform algorithms (IFTA), also referred to as Gerchberg-Saxton, or phase reconstruction by way of the transport-of-intensity equation (TIE). Of course, phase information can also be obtained by other methods, such as e.g. digital holography, ptychography or interferometric measurements, but they require different optical set-ups compared with standard microscopes.

Known difficulties with phase reconstructions from intensity focus stacks concern defocusing being manifested as a quadratic phase front in the exit pupil of the microscope. Therefore, low frequencies are affected by a change of focus to a lesser extent than higher frequencies and, therefore, slowly changing phase objects and also large, clear regions can only be reconstructed with very great difficulty. Moreover, a pupil diversification, as a result of defocusing, only maintains an intra-/extra-focal symmetry and the convergence of the algorithm is not optimal.

### SUMMARY

It is an object herein to provide an improved method for determining the phase and/or refractive index of a region of an object and also a corresponding microscope.

In an example embodiment, a method for determining the phase and/or the refractive index of a region of an object is provided. The object region is illuminated with coherent or partly coherent light and, by means of an imaging optical unit of a microscope, said imaging optical unit having an objective, along an imaging beam path from the object region as far as the image plane, is imaged into the image plane a number of times with different imaging properties and is recorded in order to obtain a plurality of intensity recordings of the object region. The phase and/or the refractive index determination is carried out on the basis of the plurality of intensity recordings. The different imaging properties differ at least in terms of different phase shifts which are additionally introduced into the imaging beam path and which are generated differently than by changing the focusing when carrying out the recordings. The different phase shifts which are additionally introduced into the imaging beam path are effected by introducing at least one optical element into the objective and/or manipulating at least one optical element of the objective.

In another example embodiment, there is provided a microscope for determining the phase and/or refractive index of a region of an object. The object region is illuminated with coherent or partly coherent light from an illumination module and, by means of an imaging optical unit of the microscope, said imaging optical unit having an objective, along an imaging beam path from the object region as far as the image plane, is imaged into the image plane a number of times with different imaging properties and is recorded in order to obtain a plurality of intensity recordings of the object region. The phase and/or refractive index determination is carried out on the basis of the plurality of intensity recordings. The different imaging properties differ at least in terms of different phase shifts which are additionally introduced into the imaging beam path and which are generated differently than by changing the focusing when carrying out the recordings. The different phase shifts which are additionally introduced into the imaging beam path are effected by introducing at least one optical element into the objective and/or manipulating at least one optical element of the objective.

Since, the different imaging properties differ at least in terms of different phase shifts which are additionally introduced into the imaging beam path and which are generated differently than by changing the focusing when carrying out the recording, it is possible to introduce precisely such phase shifts which introduce into the exit pupil a phase front which changes to a greater extent than a quadratic phase front. It is thus possible for precisely low frequencies to be influenced better, as a result of which even slowly changing phase objects (or object regions with a locally slow phase change) can be reconstructed better.

Manipulating at least one optical element of the objective can comprise e.g. displacing at least one lens for adapting the microscope to different coverslip thicknesses (or to different cover glass thicknesses), laterally displacing at least one lens of the objective, deforming at least one lens of the objective (e.g. in order to change astigmatism) and/or heating at least one lens of the objective.

Furthermore, a phase plate can be introduced into the microscope or some other phase-changing object can be introduced into the microscope in order to generate the different imaging properties.

The different imaging properties can be a non-spherical aberration, such as e.g. coma and/or astigmatism.

When adapting the microscope to different coverslip thicknesses by displacing at least one lens of the objective, it is possible to use a component of the microscope which is usually provided. Consequently, no additional hardware is necessary to carry out the method according to the invention.

The microscope can be a wide-field microscope, a confocal microscope, or some other microscope. In particular, the microscope can be configured as a transmitted-light or reflected-light microscope and/or as an inverse microscope.

The microscope can have a control unit (having e.g. a processor, a memory, an input interface, an output interface, etc.) which controls the operation of the microscope for carrying out the intensity recordings. The control unit can furthermore carry out the phase and/or refractive index determination on the basis of the plurality of intensity recordings. However, it is also possible for the control unit to carry out said phase and/or refractive index determination together with an external computer or for the control unit to communicate the intensity recordings (or else just the raw data of the recordings) to the external computer, which then carries out the phase and/or refractive index determination. In this case, the external computer is regarded as part of the microscope, even though it is not required for the operation of the microscope for carrying out the intensity recordings.

The object region can be a part of an object or the entire object.

The object can be a biological object, such as e.g. cells, tissue or other biological samples. The examination of such objects is often referred to as life science (or bioscience). In the case of such samples, it can be advantageous if the different phase shifts which are additionally introduced into the imaging beam path are effected only by introducing at least one optical element into the objective and/or manipulating at least one optical element of the objective and the focusing is not changed when carrying out the recordings. Manipulating the at least one optical element by means of the correction ring or correction slide is particularly preferred here. As a result, advantageously, no movement is exerted on the object, which is advantageous in the case of aqueous samples, for example.

Furthermore, two different intensity recordings can already be sufficient. In this case, it is preferred for a great change in the pupil wavefront to be present. This can be achieved for example by manipulating the at least one optical element by means of the correction ring or correction slide. The method according to the invention can thus be carried out rapidly. This is of interest e.g. for a high throughput and/or for real-time applications (e.g. Video applications). This can advantageously be used in life science applications, for example.

However, the object can also be an object from semiconductor lithography, such as e.g. a photomask, a DUV photomask, a semiconductor wafer or some other element. In particular, a photonic integrated circuit or a microelectromechanical system (MEMS) can also be involved.

Precisely in the case of objects from semiconductor lithography, a high accuracy is often desired. For this purpose, it is possible to carry out e.g. at least one (or exactly one) process of introducing at least one optical element into the objective and/or manipulating at least one optical element of the objective (e.g. at least one or exactly one process of manipulating the at least one optical element by means of the correction ring or correction slide) in conjunction with changing the focusing or defocusing (focus stacks). In this case, e.g. four, five, six, seven, eight, nine or more recordings are advantageous, wherein the accuracy can also be improved by introducing great changes in the pupil wavefront. Of course, such a procedure is also possible for other applications (e.g. life science) if a high accuracy is desired.

Overall, it should be noted that a focus stack combined with a pupil change by introducing at least one optical element into the objective and/or manipulating at least one optical element of the objective during the intensity recordings requires fewer intensity recordings in comparison with a pure focus stack in order to attain the same accuracy. As a result, for example, it is possible to increase the throughput with the same accuracy.

It goes without saying that the features mentioned above and those yet to be explained below can be used not only in the combinations specified but also in other combinations or on their own, without departing from the scope of the present invention.

The invention will be explained in even greater detail below on the basis of exemplary embodiments with reference to the accompanying drawings, which likewise disclose features essential to the invention. These exemplary embodiments are provided for illustration only and should not be construed as limiting. For example, a description of an exemplary embodiment having a multiplicity of elements or components should not be construed as meaning that all of these elements or components are necessary for implementation. Rather, other exemplary embodiments may also contain alternative elements and components, fewer elements or components, or additional elements or components. Elements or components of different exemplary embodiments can be combined with one another, unless stated otherwise. Modifications and variations that are described for one of the exemplary embodiments can also be applicable to other exemplary embodiments. In order to avoid repetition, elements that are the same or correspond to one another in different figures are denoted by the same reference signs and are not explained repeatedly.

### BRIEF DESCRIPTION OF THE DRAWINGS

FIG. 1 shows a schematic view of an embodiment of the microscope in accordance with embodiments of the invention.

FIG. 2 shows an illustration of phase shifts plotted against the normalized pupil coordinate.

FIG. 3 shows a schematic illustration of the object phase of a test object in the image plane.

FIGS. 4a-4e show illustrations of the known object phase at the focus (solid line), the simulated coherent image phase (dashed line) and the reconstructed coherent image phase (dotted line) in accordance with the sectional line A-A in FIG. 3 for a focus stack with five planes.

FIGS. 5a-5e show illustrations in accordance with FIGS. 4a-4e taking into account Z9 manipulations in the third to fifth image planes.

FIGS. 6a-6e show illustrations in accordance with FIGS. 5a-5e with an additional Z16 manipulation in the second and fourth image planes in comparison with the manipulations in accordance with FIGS. 5a-5e.

### DETAILED DESCRIPTION

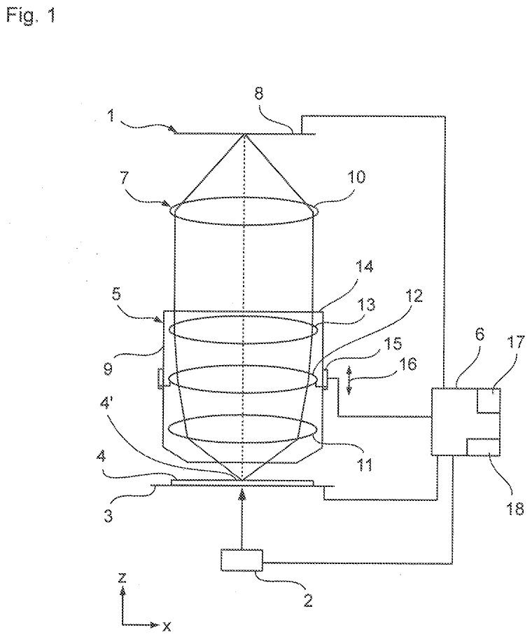

In the case of the embodiment shown in FIG. 1, the microscope 1 according to the invention comprises an illumination module 2, an object stage 3 for mounting an object 4 to be recorded, an imaging module 5 and a control unit 6.

The microscope 1 illustrated schematically in FIG. 1 is configured as a wide-field microscope. However, it is e.g. also possible for the microscope 1 to be configured as a confocal microscope.

The imaging module 5 comprises an imaging optical unit 7 and a detector 8. The imaging optical unit 7 comprises an objective 9 and a downstream tube optical unit 10. In the exemplary embodiment described here, the objective 9 has a first, a second and a third partial optical unit 11, 12 and 13, wherein each partial optical unit 11-13 is represented schematically by a lens and can comprise one or more lenses. The three partial optical units 11-13 are arranged in a housing 14 of the objective 9 and mounted such that, by means of a motorized correction ring 15, for example, the second partial optical unit 12 is displaceable along the imaging direction relative to the first and third partial optical units 11, 13, as is indicated by the double-headed arrow 16.

The control unit 6 can have a processor 17 and a memory 18, for example, and can be connected to the detector 8, the objective 9 (in particular the correction ring 15), the object stage 3 and the illumination module 2 in order to control the operation of the microscope 1.

During operation, the illumination module 2, which can have a laser, for example, can emit coherent or partly coherent light and thus illuminate the object 4 to be recorded (or a region 4′ to be imaged of the object 4), which is then imaged into an image plane by means of the imaging optical unit 7, in which image plane the detector 8 (e.g. a CMOS sensor or a CCD sensor) is positioned.

By means of the microscope 1 according to the invention, besides a conventional intensity recording of the object 4 or of the object region 4′, it is also possible to determine the phase of the light in the image plane of an imaging of the object 4 (and thus of the object region 4′) carried out by means of the microscope 1, e.g. as follows.

Two, three, four, five or more intensity recordings with different focus positions (a so-called defocus stack) are recorded, a different setting of the correction ring 15 being set, however, for each focus position. By virtue of these different settings by means of the correction ring 15, in the course of the imaging by means of the imaging optical unit 7, different spherical aberrations which are not a consequence of the defocusing are introduced into the imaging, such that for each recording, as a result of that, different phase shifts are present during the recording.

From the different intensity recordings thus present, the object phase can be reconstructed by means of methods which are known to a person skilled in the art. Known phase retrieval algorithms are e.g. iterative Fourier transform algorithms (IFTA), which may also be referred to as Gerchberg-Saxton. A phase reconstruction is also possible by way of the transport-of-intensity equation (TIE).

Since a defocusing leads only to a quadratic phase change as a function of the lateral position (e.g. as a function of the radial coordinate in the pupil plane) in the pupil of the microscope 1, low frequencies are influenced in the course of a change of focus to a lesser extent than higher frequencies, and so slowly changing object phases can only be reconstructed with difficulty.

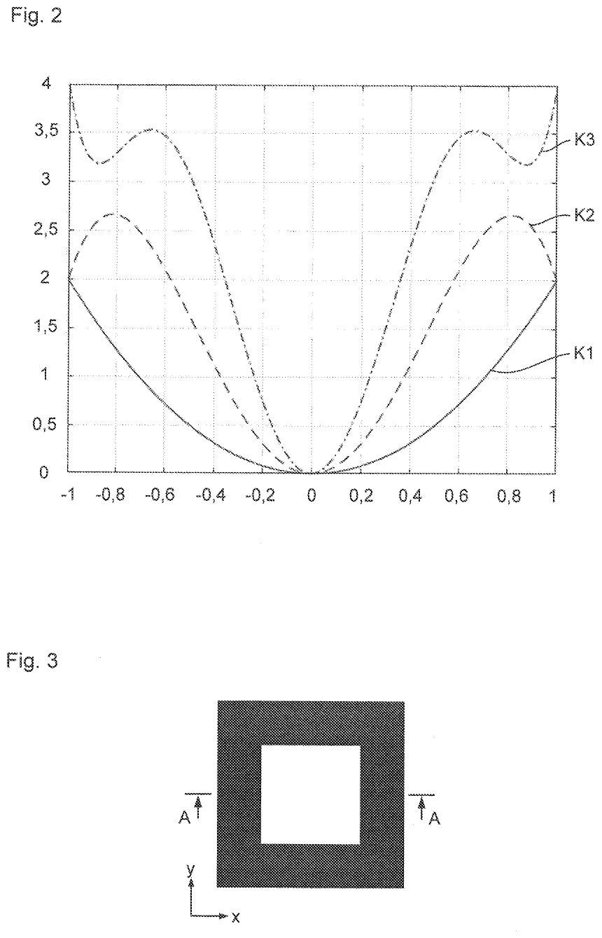

However, since the invention stipulates the additional phase shift as a result of the different settings of the correction ring 15 and the different spherical aberrations caused thereby, even low-frequency components are influenced to a greater extent, as can be inferred from the subsequent illustration in FIG. 2.

In this case, the normalized pupil coordinate is plotted along the abscissa and the pupil phase (in rad) is plotted along the ordinate, the curve K1 showing the portion of the defocusing (Z4 manipulation). The curve K2 shows the Z4 manipulation plus a Z9 manipulation and the curve K3 shows a Z4 manipulation plus a Z9 manipulation and a Z16 manipulation. The Z4, Z9 and Z16 manipulations are Zernike polynomials which are orthogonal polynomials in the unit circle. These are often used for describing optical wavefront aberrations in pupils of optical systems. For the definition of the spherical aberration described, the following notation (also referred to as fringe notation) is used here (where r is the normalized radial pupil coordinate):

Z4(r)=2r²−1

Z9(r)=6r⁴−6r²+1

Z16(r)=20r⁶−30r⁴+12r²−1

As is evident in particular from a comparison of the curves K1 and K3, precisely at low frequencies there is a greater change in the pupil phase as a result of the additional spherical aberration owing to the different settings of the correction ring 15, as a result of which a better reconstruction of the object phase is possible.

With the microscope 1 according to the invention, it is thus possible to carry out an intrinsic pupil manipulation by means of the different settings of the correction ring 15, which is more advantageous than a pure focus variation, without additional hardware needing to be provided on the microscope 1.

Of course, it is also possible not to change the focus position during the creation of the intensity recording, and thus to generate the different phase shifts only by way of the different settings of the correction ring 15. Moreover, it is possible to perform in each case a plurality of different correction ring settings for each of the different focus positions.

Besides the phase reconstruction methods already described, other methods known to a person skilled in the art can also be used, such as e.g. pixelwise model-based object optimization by means of a merit function on the intensity recordings (differences or similarities between measured intensity recordings and extrapolated intensity recordings) and gradient-based error feedback. A parameterized object optimization is also possible instead of the pixelwise object optimization. Phase reconstructions by way of deep learning are also possible.

The reconstructed object phases can be two-dimensional phases or three-dimensional phases. Analogously to the reconstruction of two-dimensional object phases, during the reconstruction of three-dimensional object phases or a refractive index distribution (preferably two- or three-dimensional), it is possible here once again to apply model-based object reconstruction, IFTA-based projection algorithms or deep learning models.

In the described procedure of the different settings of the correction ring 15, the resultant aberrations are known in principle and can be expressed in the specified Zernike coefficients given knowledge of the optics design.

However, for the case of the described different settings by means of the correction ring 15, it can also be advantageous to carry out a calibration for determining the resultant pupil phase change. Furthermore, such a calibration is advantageous for intervention possibilities according to the invention which lead to the desired different imaging properties and thus different phase shifts which can be modelled only with difficulty or cannot be modelled at all. In this regard, e.g. at least one of the optical elements of the microscope 1 can be heated, deformed, laterally displaced and/or axially displaced. For this purpose, the resultant influence on the pupil phase has to be measured so that a desired calibration can be carried out.

In a first step, for a repeatably settable pupil phase manipulation (setting of the correction ring 15, setting of a temperature, mechanical displacement and/or deformation of a lens, etc.), a measurement of Zernike coefficients can be carried out. This can be achieved e.g. by means of measurement of a focus stack of a small pinhole object (and thus of a test object) having an extent in the range of the wavelength and an optimization of a Zernike-parameterized forward propagation model for this focus stack. This is carried out for each step of the pupil manipulation. The resulting Zernike coefficients per pupil variation step are then used in the object phase reconstruction.

In a second step, the Zernike coefficients of the first step can be used as starting values and can be optimized further within the object phase reconstruction in order to attain a best match with the object focus stack.

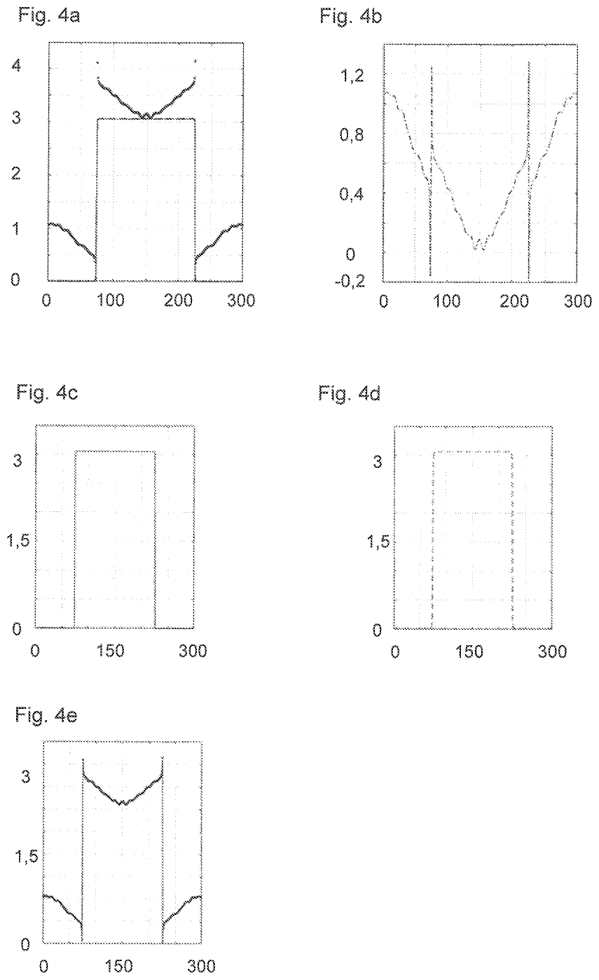

In FIG. 3, the object phase with a sudden phase change at 175°=3.054 rad is simulated schematically, which object phase is present in the image plane (at the detector 8), the phase 0 being represented in a black color and the phase of 3.045 rad being represented in a white color (here white square within the black frame). A partially coherent illumination with an imaging NA (NA=numerical aperture) of 0.8, an illumination NA of 0.08 and a wavelength of 500 nm was assumed. The dashed line is the sectional line for the subsequent FIGS. 4 to 6.

First a partially coherent focus stack (five planes) of this object is simulated. The object can be reconstructed therefrom by means of a partially coherent phase reconstruction. The latter can contain a forward model propagation of the object field (or of the object region) up to the sensor intensity, and a backpropagation of the pixelwise intensity differences (merit function) in order to obtain a best possible estimation for the pixelwise optimization of the object amplitude values and the object phase values. From the resulting reconstructed complex object, the coherent axial image phase can then be compared with the known coherent axial image phase obtained from the known object. Both phase profiles along the sectional line A-A in FIG. 3 are shown in FIG. 4a, wherein the x-coordinate in pixels is plotted along the abscissa, with a pixel size of 53 nm/pixel having been chosen, and the phase in rad is plotted along the ordinate (the same applies to FIGS. 4b-4e). The phase difference between the reconstructed phase and the actual phase is shown in FIG. 4b. This reveals that in the reconstruction, errors of up to 1.2 rad occur in the case of the constant phase plateau, since the corresponding slowly varying phase is not influenced to a very great extent by just the defocus variation. In this regard, only the focus variation (Z4 manipulation) was taken into account in the phase reconstruction as shown in FIGS. 4a-4e. In FIG. 4a, the known object phase (solid line), the simulated coherent image phase (dashed line) and the reconstructed coherent image phase (dotted line) are compared. For the sake of better clarity, the known object phase is shown by itself in FIG. 4c, the simulated coherent image phase is shown by itself in FIG. 4d and the reconstructed coherent image phase is shown by itself in FIG. 4e. FIG. 4b shows the reconstruction error in rad as the difference between the simulated coherent image phase and the reconstructed coherent image phase.

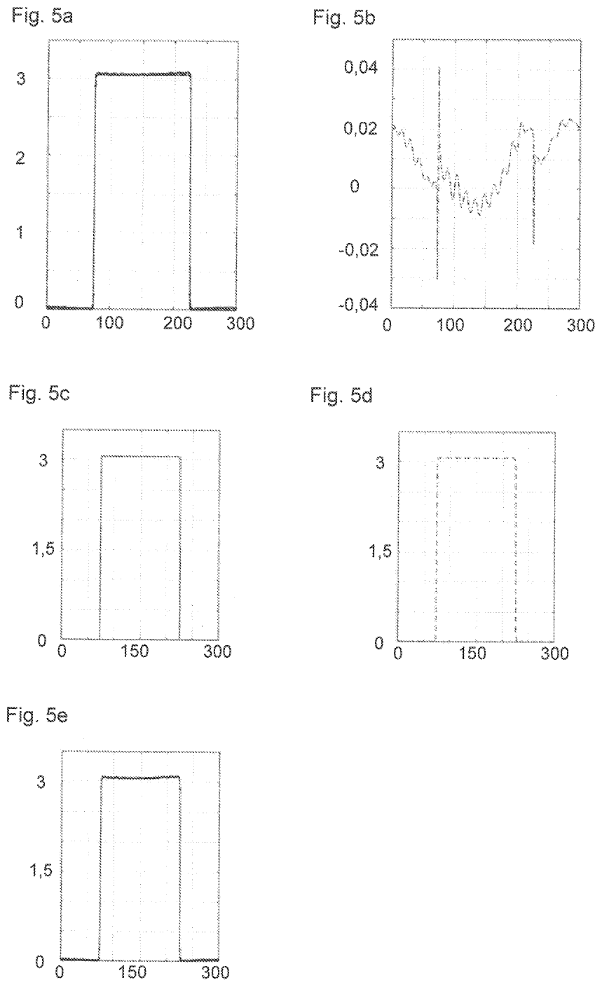

A distinct improvement can be attained if use is made of a focus stack having five focus planes with a simulated change of the Z9 value, since this is the main portion of a phase change introduced by changing the correction ring 15. Here, therefore, for the first plane and the second plane, a constant value of Z9 was added to the pupil manipulation (of the same intensity), whereas the planes three to five were not changed. The result is shown in FIGS. 5a-5e (in the same way as in FIGS. 4a-4e). The error was thereby able to be reduced by a factor of 10 compared with a pure defocus manipulation, even though the number of recorded intensity images and the defocus region are unchanged.

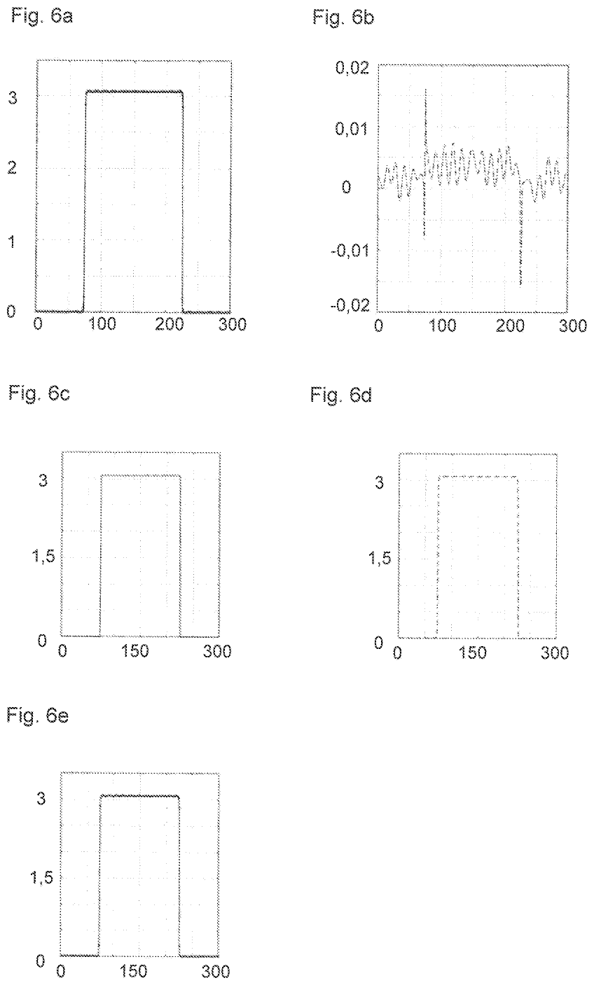

A further improvement can be achieved if a Z16 manipulation is added to the second and fourth planes. The result of this phase reconstruction is shown in FIGS. 6a-6e (in the same way as in FIGS. 4a-4e). The phase difference between the reconstruction and the known phase is now less than 0.01 rad. That is a distinct improvement in the accuracy of the phase reconstruction in comparison with the variation of the defocus, and this improvement can be attained without having to increase the number of images and thus the recording time.

Since the phase reconstruction with the described aberration manipulation (without taking account of a defocusing) has high robustness, it is possible to reduce the number of image planes for a pure defocus-based reconstruction in order to attain the same accuracy. Consequently, the recording time for creating the intensity recordings can be reduced according to the invention.

What is claimed is:

1. A method for determining at least one of the phase and the refractive index of a region of an object, comprising:
illuminating the object region with coherent or partly coherent light along an imaging beam path from the object region as far as the image plane via an imaging optical unit of a microscope, said imaging optical unit including an objective;
imaging the object region into the image plane a number of times with different imaging properties;
recording the imagings of the object region in order to obtain a plurality of intensity recordings of the object region; and
determining at least one of the phase and the refractive index on the basis of the plurality of intensity recordings,
wherein the different imaging properties differ at least in terms of different phase shifts which are additionally introduced into the imaging beam path and which are generated differently than by changing the focusing when carrying out the recordings, and
wherein the different phase shifts which are additionally introduced into the imaging beam path are effected by at least one of introducing at least one optical element into the objective and manipulating at least one optical element of the objective.

2. The method of claim 1, wherein the objective has at least one displaceable lens for adapting the microscope to different coverslip thicknesses, and wherein manipulating the at least one optical element of the objective comprises displacing the displaceable lens.

3. The method of claim 2, wherein the objective comprises a correction ring or a correction slide to displace the at least one displaceable lens, wherein manipulating the at least one optical element of the objective is further comprises actuating the correction ring or the correction slide.

4. The method of claim 2, wherein manipulating the at least one optical element of the objective further comprises at least one of changing the temperature of the at least one optical element and deforming the at least one optical element.

5. The method of claim 2, further comprising carrying out a two-dimensional phase determination.

6. The method of claim 2, wherein the different intensity recordings of the object region each differ in terms of the different phase shifts which are additionally introduced into the imaging beam path and which are generated differently than by changing the focusing when carrying out the recordings, and in terms of phase shifts which are introduced into the imaging beam path and which are generated by changing the focusing when carrying out the recordings, wherein at least one of a three-dimensional phase determination and a refractive index determination is carried out on the basis of the plurality of intensity recordings.

7. The method of claim 2, further comprising establishing a mathematical model for describing the phase shifts which are additionally introduced into the imaging beam path via the different imaging properties, wherein the mathematical model takes into account the phase and/or refractive index determination.

8. The method of claim 7, further comprising:
illuminating a known test object with coherent or partly coherent light by the imaging optical unit of the microscope along the imaging beam path;
imaging the known test object into the image plane a number of times with different imaging properties;
recording the imagings of the known test object in order to obtain a plurality of intensity recordings of the test object,
wherein the different imaging properties differ in terms of different phase shifts which are additionally introduced into the imaging beam path and which are generated differently than by changing the focusing when carrying out the recordings; and
establishing the mathematical model on the basis of the recordings of the test object.

9. The method of claim 1, wherein manipulating the at least one optical element of the objective comprises at least one of changing the temperature of the at least one optical element and of deforming the at least one optical element.

10. The method of claim 1, further comprising establishing a mathematical model for describing the phase shifts which are additionally introduced into the imaging beam path via the different imaging properties, wherein the mathematical model takes into account the phase and/or refractive index determination.

11. The method of claim 10, further comprising:
illuminating a known test object with coherent or partly coherent light by the imaging optical unit of the microscope along the imaging beam path;
imaging the known test object into the image plane a number of times with different imaging properties;
recording the imagings of the known test object in order to obtain a plurality of intensity recordings of the test object,
wherein the different imaging properties differ in terms of different phase shifts which are additionally introduced into the imaging beam path and which are generated differently than by changing the focusing when carrying out the recordings; and
establishing the mathematical model on the basis of the recordings of the test object.

12. The method of claim 1, further comprising carrying out a two-dimensional phase determination.

13. The method of claim 1, wherein the different intensity recordings of the object region each differ in terms of the different phase shifts which are additionally introduced into the imaging beam path and which are generated differently than by changing the focusing when carrying out the recordings, and in terms of phase shifts which are introduced into the imaging beam path and which are generated by changing the focusing when carrying out the recordings, wherein at least one of a three-dimensional phase determination and a refractive index determination is carried out on the basis of the plurality of intensity recordings.

14. A microscope for determining at least one of the phase and/or of the refractive index of a region of an object, the microscope comprising an imaging optical unit and an objective, wherein the determining method comprises:
illuminating the object region with coherent or partly coherent light along an imaging beam path from the object region as far as the image plane via the imaging optical unit of the microscope, said imaging optical unit comprising the objective;
imaging the object region into the image plane a number of times with different imaging properties;
recording the imagings of the object region in order to obtain a plurality of intensity recordings of the object region; and
determining at least one of the phase and the refractive index on the basis of the plurality of intensity recordings,
wherein the different imaging properties differ at least in terms of different phase shifts which are additionally introduced into the imaging beam path and which are generated differently than by changing the focusing when carrying out the recordings, and
wherein the different phase shifts which are additionally introduced into the imaging beam path are effected by at least one of introducing at least one optical element into the objective and manipulating at least one optical element of the objective.
